(19) United States
(12) Patent Application Publication
(10) Pub. No.: US 2026/0020552 A1
(43) Pub. Date: Jan. 22, 2026

(54) CHUM TORPEDO DISBURSEMENT MODULE

(71) Applicant: John J. Saltis, Hampton, NY (US)

(72) Inventor: John J. Saltis, Hampton, NY (US)

(21) Appl. No.: 19/270,166

(22) Filed: Jul. 15, 2025

Related U.S. Application Data
(60) Provisional application No. 63/671,903, filed on Jul. 16, 2024.

(51) Int. Cl. A01K 97/02; B63G 8/00; B63G 8/20; B63G 8/42

(52) U.S. Cl. CPC A01K 97/02; B63G 8/001; B63G 8/20; B63G 8/42; B63G 2008/002

(57) ABSTRACT

Apparatus and associated methods relate to a chum torpedo designed for deep-water fishing. In an illustrative example, a chum torpedo includes a chum-containing device, a torpedo, and a system configured to attach to place a fishing line in a turbulent stream of the torpedo at a predetermined depth. The torpedo, for example, may be attached to a downrigger cable or a downrigger cable ball, and may enter a travel mode as it travels at a predetermined speed to agitate the torpedo. Various embodiments may advantageously include a fin system—including both forward and backward fins-to stabilize the torpedo and create currents for dispersing chum effectively.

### CROSS-REFERENCE TO RELATED APPLICATIONS

This application is a non-provisional and claims the benefit of U.S. Application Ser. No. 63/671,903, titled “CHUM TORPEDO DISBURSEMENT MODULE,” filed by John J. Saltis on Jul. 16, 2024.

This application incorporates the entire contents of the foregoing application(s) herein by reference.

### TECHNICAL FIELD

Various embodiments relate generally to fishing and aquatic recreation.

### BACKGROUND

Fishing may involve the capture of aquatic animals from bodies of water, where techniques may vary from angling with hooks and lines to netting. Aquatic recreation may include activities such as boating and water sports, which may utilize various types of equipment designed for these purposes.

Methods for fishing may encompass the use of natural or synthetic baits, and modern technological aids such as sonar and GPS may enhance the effectiveness of these methods. Aquatic recreational activities may often require safety equipment and may be regulated by local or international standards to ensure the safety of participants.

The equipment used in fishing and aquatic recreation may be designed to withstand various environmental conditions encountered in freshwater or marine settings. Patents in this field may focus on innovations in gear durability, efficiency, and environmental sustainability, which may contribute to enhanced experiences in both fishing and recreational activities.

### SUMMARY

Apparatus and associated methods relate to a chum torpedo designed for deep-water fishing. In an illustrative example, a chum torpedo includes a chum-containing device, a torpedo, and a system configured to attach to place a fishing line in a turbulent stream of the torpedo at a predetermined depth. The torpedo, for example, may be attached to a downrigger cable or a downrigger cable ball, and may enter a travel mode as it travels at a predetermined speed to agitate the torpedo. Various embodiments may advantageously include a fin system—including both forward and backward fins—to stabilize the torpedo and create currents for dispersing chum effectively.

Various embodiments may achieve one or more advantages. For example, some embodiments may allow for the precise release of scent materials at a predetermined depth, enhancing bait dispersal and improving catch rates. The attachment of the fishing line to a release mechanism, releasably coupled to the fishing line, allows for immediate response when a fish bites. The force of the bite triggers the release, enabling the fisherman to efficiently reel in the catch. This setup may, for example, increase the likelihood of attracting fish with effectively dispersed scent materials. The submersion process may, for example, streamline the process of hooking and retrieving fish, which may be particularly beneficial in competitive fishing scenarios or in areas with difficult ocean currents

In some embodiments, the chum torpedo disbursement module, may be designed with a cylindrical tube featuring threaded ends that facilitate the containment and guided release of scents or chum. This chum torpedo disbursement module may include holes at both threaded ends, allowing water to enter and exit, which may carry the scent to the desired depth. Furthermore, the chum torpedo disbursement module may be equipped with a threaded port on the top, enabling users to easily load scents or chopped fish directly into the device. Additionally, this module may feature connections on both the top and bottom, allowing for secure attachment to a downrigger's cannonball and cable, respectively. The inclusion of a fin on the bottom of the device may assist in maintaining a straight trajectory through water, enhancing the effectiveness of scent disbursement.

The chum torpedo disbursement module may also integrate a central shaft with a propeller at the rear, which serves multiple functions. Primarily, this chum torpedo disbursement module may generate vibrations through the propeller's motion, which can stimulate fish to strike by mimicking the movement of prey. Secondly, as the boat moves, the propeller may act to disperse the contained scent into an underwater cloud, effectively creating a scent trail that leads fish to the lure. The water flows through the device, from the front holes to the rear, may pick up the scent particles inside the chum torpedo disbursement module and distribute them into the surrounding water. In some versions, an auger may be included as part of the shaft, which could dissect real bait into finer pieces, enhancing the scent dispersion. This feature of the chum torpedo disbursement module may significantly increase the likelihood of attracting target fish species, underlining the significance of its design and functional advances.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary Chum Torpedo Disbursement Module employed in an illustrative use-case scenario.

FIG. 2A depicts a front perspective view of the exemplary Chum Torpedo Disbursement Module with one or more cartridges.

FIG. 2B depicts a front perspective view of the exemplary Chum Torpedo Disbursement Module.

FIG. 2C depicts a side perspective view of exemplary one or more cartridges in the exemplary use-case scenario of FIG. 1 without the Chum Torpedo Disbursement Module.

FIG. 2D depicts a perspective view of the exemplary Chum Torpedo Disbursement Module in an exemplary modular embodiment.

FIG. 2E depicts a rear view of exemplary one or more cartridges, an exemplary slide-on coupling feature and an exemplary receiving track.

FIG. 3 depicts a rear perspective view of the exemplary Chum Torpedo Disbursement Module.

FIG. 4 depicts a rear view of the exemplary Chum Torpedo Disbursement Module.

FIG. 5 depicts a front view of the exemplary Chum Torpedo Disbursement Module.

FIG. 6 depicts a top view of the exemplary Chum Torpedo Disbursement Module.

FIG. 7 depicts a bottom perspective view of the exemplary Chum Torpedo Disbursement Module.

FIG. 8 depicts a left side view of an exemplary Chum Torpedo Disbursement Module.

FIG. 9 depicts a right-side view of the exemplary Chum Torpedo Disbursement Module.

FIG. 10 depicts a colored side view of the exemplary Chum Torpedo Disbursement Module.

FIG. 11 depicts a cross-section of the exemplary Chum Torpedo Disbursement Module. Like reference symbols in the various drawings indicate like elements.

### DETAILED DESCRIPTION OF ILLUSTRATIVE EMBODIMENTS

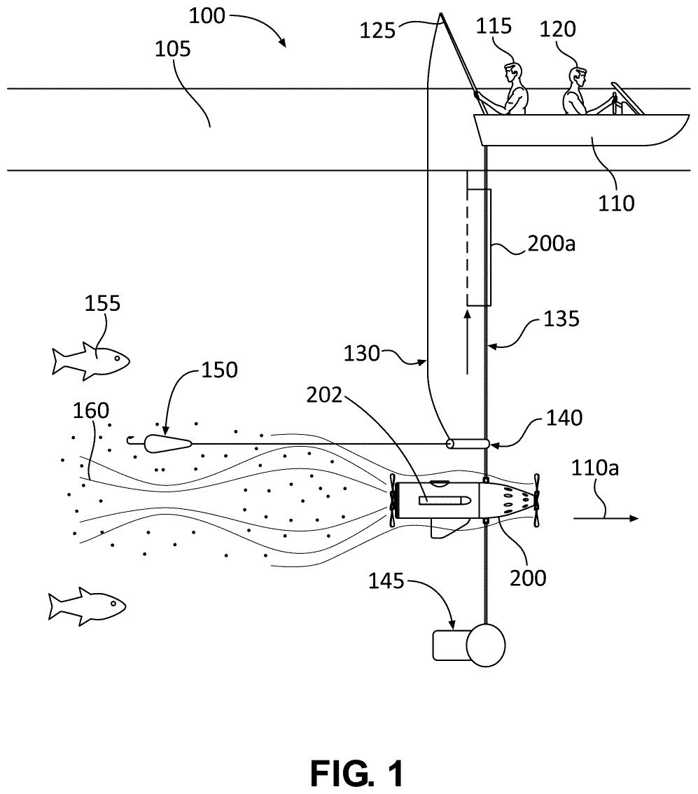

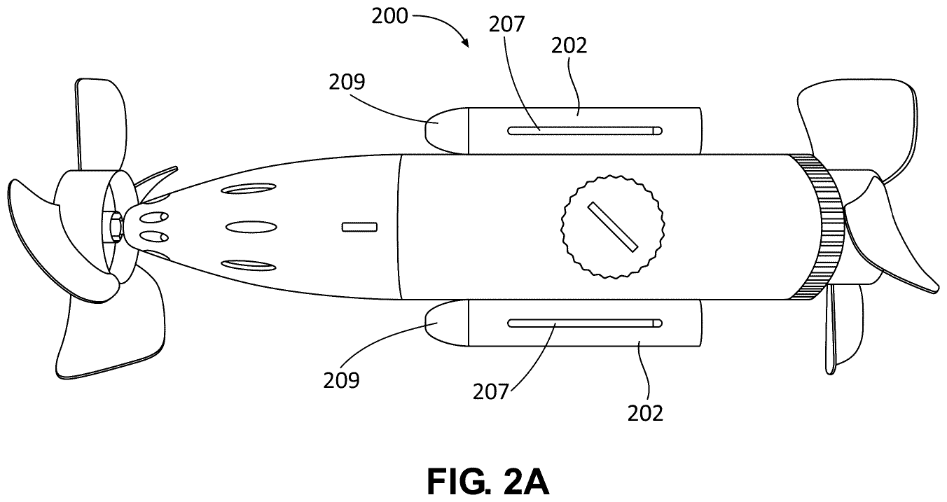

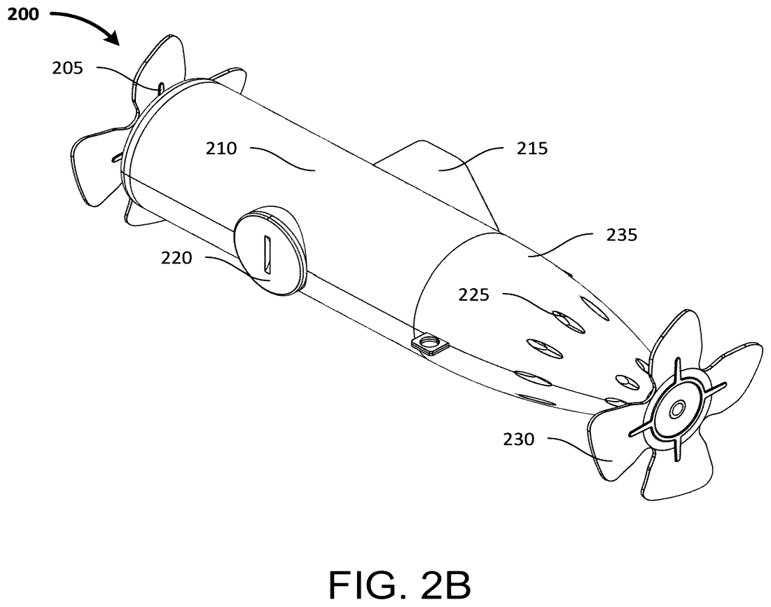

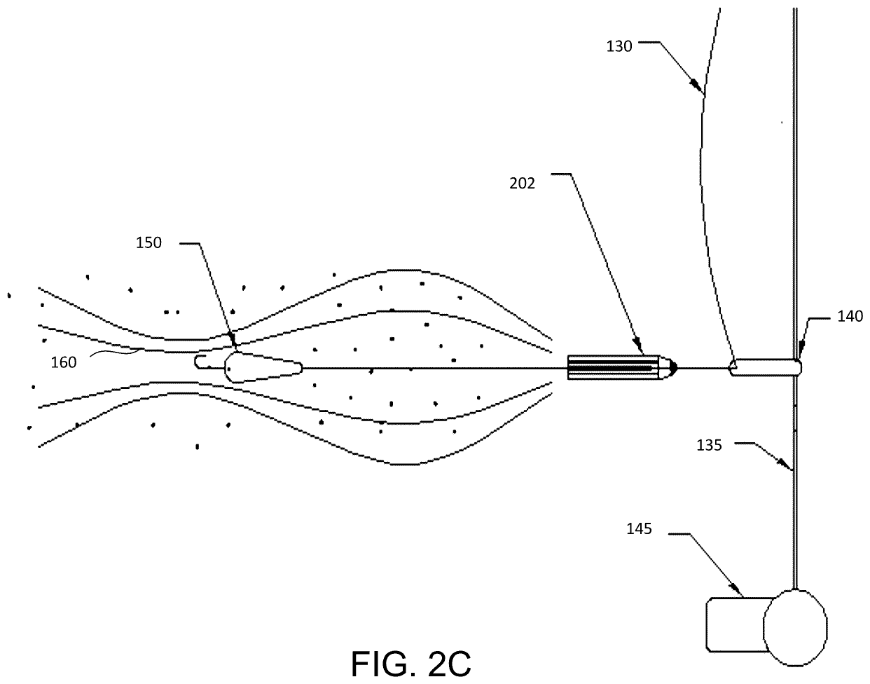

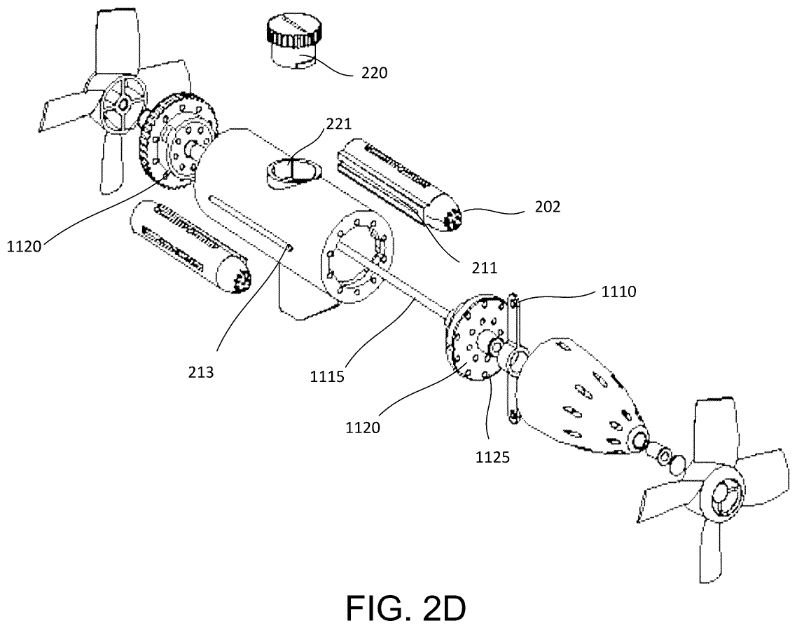

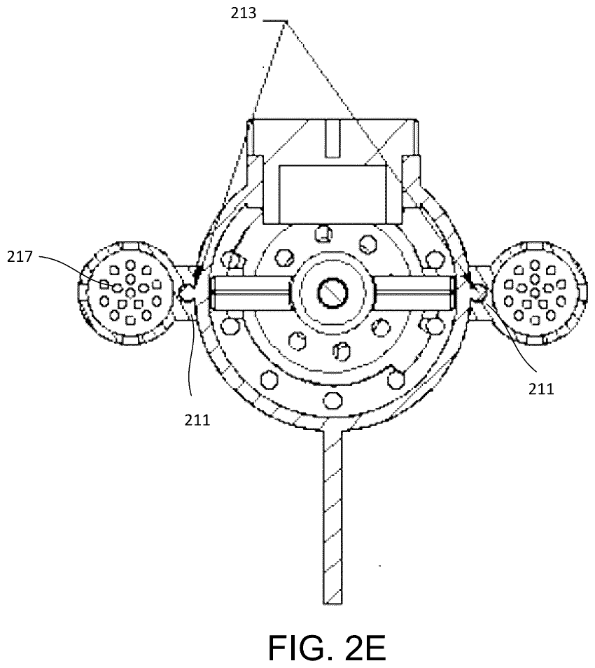

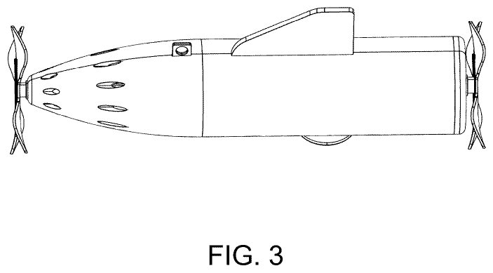

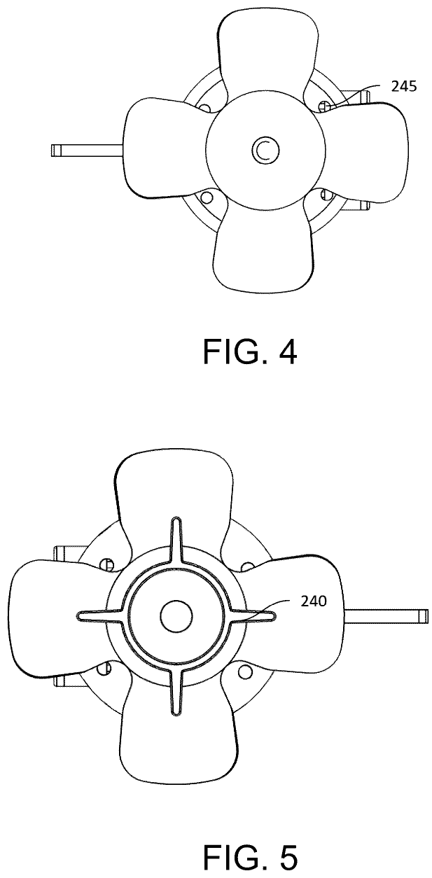

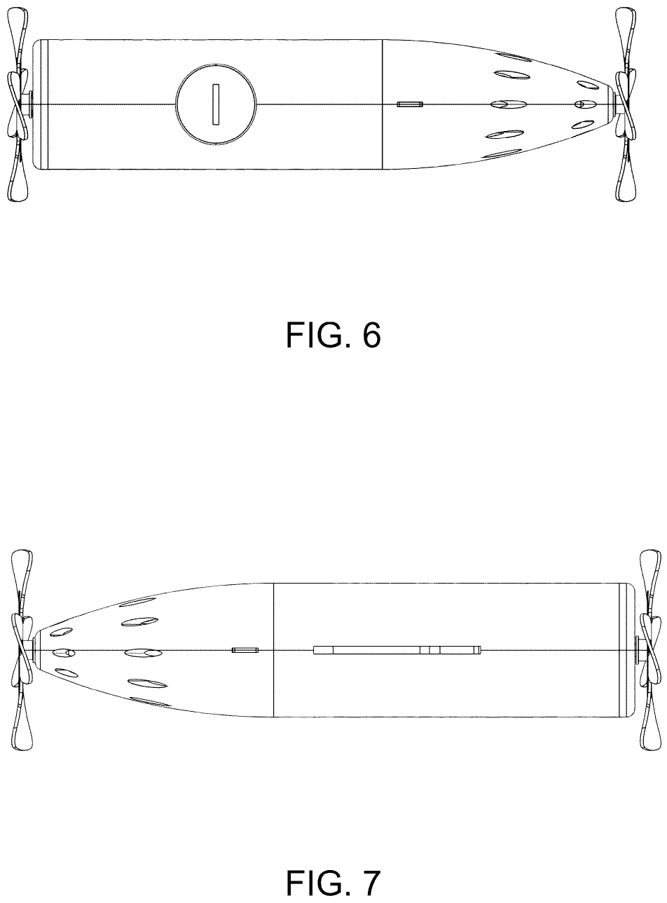

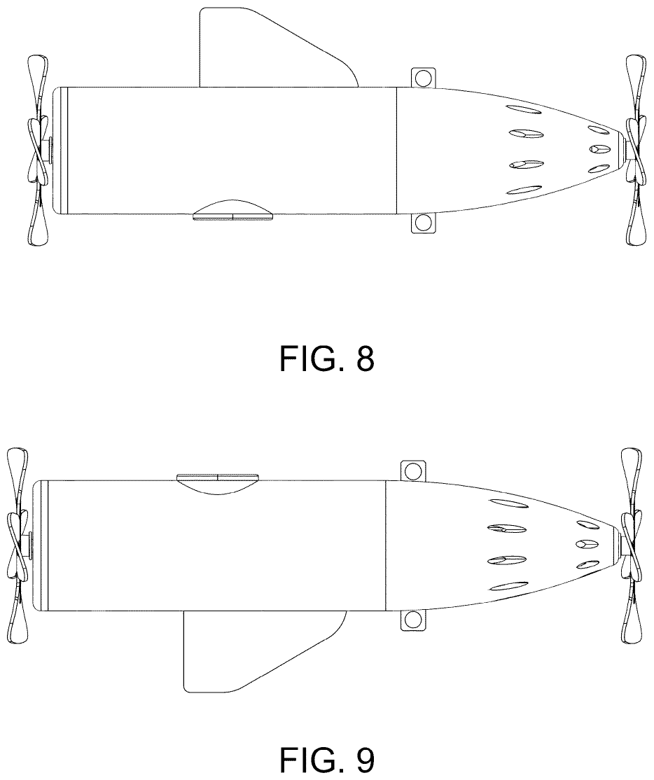

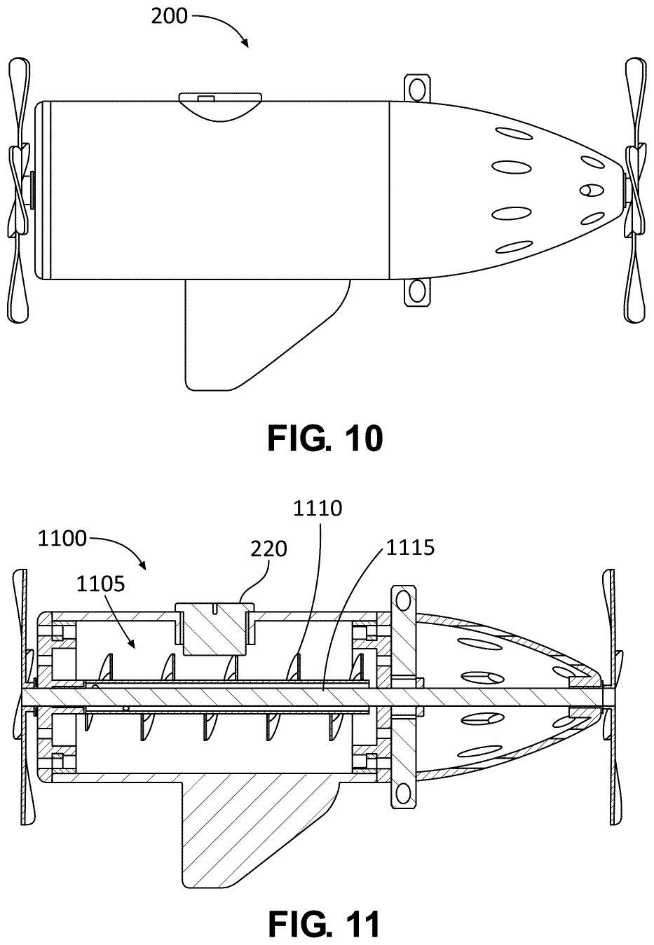

To aid understanding, this document is organized as follows. First, to help introduce discussion of various embodiments, an illustrative use-case scenario is introduced with reference to FIGS. 1. Second, that introduction leads into a description with reference to FIGS. 2-10 of some exemplary embodiments of the Chum Torpedo Disbursement Module. Third, that leads to a discussion of the internal components of the Chum Torpedo Disbursement Module in FIG. 11.

FIG. 1 depicts an exemplary Chum Torpedo Disbursement Module employed in an illustrative use-case scenario 100. The illustrative use-case scenario 100 includes an aquatic vehicle 110. By way of example, and not limitation, the aquatic vehicle 110 may include a boat.

The aquatic vehicle 110 is traveling in a direction 110a. The aquatic vehicle 110 is in a body of water 105. The body of water may, for example, include a lake. The body of water may, for example, include a sea. The body of water may, for example, include an ocean. The aquatic vehicle 110 is being driven by a driver 120.

The illustrative use-case scenario 100 includes a chum torpedo disbursement module 200. The illustrative use-case scenario 100 may, for example, include one or more cartridges 202, as depicted in FIG. 2C. The illustrative use-case scenario 100 includes a user 115 of the chum torpedo disbursement module 200.

The chum torpedo disbursement module 200 may, for example, be placed at a predetermined depth 200a. The chum torpedo disbursement module 200 may, for example, be placed at 10 m in depth. The chum torpedo disbursement module 200 may, for example, be placed at 20 m in depth. The chum torpedo disbursement module 200 may, for example, be placed at 30 m in depth. The chum torpedo disbursement module 200 may, for example, be placed at 50 m in depth. The chum torpedo disbursement module 200 may, for example, be placed at 150 m in depth. The chum torpedo disbursement module 200 may, for example, be placed at 200 m in depth. The chum torpedo disbursement module 200 may, for example, be placed at 250 m in depth.

The user 115 is fishing using a fishing rod 125. The fishing rod 125 includes a fishing line 130. The fishing line 130 couples to a lure of choice 150. The chum torpedo disbursement module 200 is coupled to the aquatic vehicle 110 with a cable 135. The cable 135 may, for example, include a downrigger cable. The chum torpedo disbursement module 200 may, for example, be coupled to a depth control apparatus 145. The depth control apparatus may, for example, include a downrigger ball. The depth control apparatus 145 may, for example, be a weight used to submerge the torpedo. The depth control apparatus 145 may, for example, include a retractable anchor operatively coupled to the chum torpedo disbursement module 200. Calculations may, for example, be used to determine the amount of downward force needed to be applied via a weight to the amount of lift force generated by movement of the chum torpedo disbursement module 200 so that the chum torpedo disbursement module 200 stays at the predetermined depth 200a (e.g., at a predetermined speed force are zero). Tension of the cable 135 may, for example, be used such that the chum torpedo disbursement module 200 does not become disconnected from the aquatic vehicle 110.

The fishing line 130 couples to a release 140. The illustrative use-case scenario 100 includes fish 155. The chum torpedo disbursement module 200 disperses scent material in a scent material trail 160. The scent material trail 160 disbursement may, for example, be dispersed by the flow of water being inputted into the chum torpedo disbursement module 200, and release from behind the chum torpedo disbursement module 200 (e.g., the chum torpedo disbursement module 200 may, for example, receive an input flow, and release an output flow). The scent material may, for example, include material configured to attract fish. For example, the scent material may include chum. For example, the scent material may include gels. The scent material may, for example, include oils. The scent material may, for example, include sprays.

The chum torpedo disbursement module 200 may, for example, include an internal nozzle or internal diffuser to change velocity of flow from pressure. The release 140 may, for example, include a releasably coupling device that releases the fishing line 130, so the user 115 may pull up after the fish bite onto the line. The fish 155 may, for example, be attracted to the turbulence and chum trail, and then bite onto the lure, causing the release to release, allowing the fisherman to attempt to reel the fish 155 in.

FIGS. 2A-10 depict some exemplary views and embodiments of the exemplary chum torpedo disbursement module 200. The chum torpedo disbursement module 200 may, for example, include a guiding fin 215. The chum torpedo disbursement module 200 may, for example, include a rear propeller 205. The chum torpedo disbursement module 200 may, for example, include a forward propeller 230. The chum torpedo disbursement module 200 includes a set of predetermined inlets 225 centered on a longitudinal axis bisecting the chum torpedo. The chum torpedo disbursement module 200 may, for example, include an inlet cap 220. The chum torpedo disbursement module 200 includes an inlet 221. The inlet 221 may, for example, be configured to receive scent materials. The inlet 221 may, for example, be configured to receive the inlet cap 220 such that, the inlet cap 220 may advantageously prevent scent material from being disposed from the inlet 221 while the inlet cap 220 is in the inlet 221.

Chum and/or fish attractive substances/scents may, for example, be inserted and/or stowed in the set of predetermined inlets 225 to be dispersed over a predetermined period while the chum torpedo disbursement module 200 is in use. The chum torpedo disbursement module 200 may, for example, include a cylindrical frame 210. The chum torpedo disbursement module 200 may, for example, include a front guiding fin 240. The chum torpedo disbursement module 200 includes one or more rear outlets 245, where the scent material trail 160 may, for example, be dispersed from.

One or more cartridges 202 may, for example, operatively couple the chum torpedo disbursement module 200. The one or more cartridges 202 may, for example, slidably couple the chum torpedo disbursement module 200. For example, the one or more cartridges 202 may, for example, include a slide-on coupling feature 211. The slide-on coupling feature 211 may, for example, slide onto a corresponding receiving track 213 of the chum torpedo disbursement module 200. The one or more cartridges 202 may, for example, may also be used separately in-line without the chum torpedo disbursement module 200, as is depicted in FIG. 2C. The chum torpedo disbursement module 200 may, for example, be modular, as depicted in FIG. 2D.

The one or more cartridges 202 may, for example, include one or more apertures 207. The one or more apertures 207 may, for example, be configured to receive scent materials. The one or more cartridges 202 may, for example, include one or more outlets 217 configured to release scent materials as the one or more cartridges 202 move through an aqueous fluid. For example, water flow passing by may dissolve away the scent of the scent material. The one or more cartridges 202 may, for example, include ribs near the center of the one or more apertures 207 to increase the strength.

The scent materials may, for example, include materials comprising a smell that attracts fish. For example, the scent material may include chum. For example, the scent material may include gels. The scent material may, for example, include oils. The scent material may, for example, include sprays.

The one or more cartridges 202 may, for example, include one or more caps 209. The one or more caps 209 may, for example, releasably couple the one or more cartridges 202. If the one or more caps 209 is removed from the one or more cartridges 202, then the one or more cartridges 202 may include an aperture in the position where the one or more caps 209 were located. The aperture in the position where the one or more caps 209 were located may, for example, be configured to receive scent materials such that the one or more cartridges 202 may store the scent materials in an internal cavity within the one or more cartridges 202. If the internal cavity within the one or more cartridges 202 is filled with scent materials, then the one or more caps 209 may, for example, be operatively couple again to the one more cartridges such that the one or more caps may, for example, advantageously 209 secure the scent materials within the one or more cartridges 202.

FIG. 11 depicts a cross-section 1100 of the exemplary chum torpedo disbursement module 200. The cross section 1100 includes a view of the internal flow enabler 1105. The internal flow enabler 1105 may, for example, include blades 1110 that enable flow from the set of predetermined inlets 225 to the one or more rear outlets 245 from the front to the rear of the chum torpedo disbursement module 200. The internal flow enabler 1105 may, for example, include a shaft 1115 coupling the blades 1110. The shaft 1115 may, for example, be affixed in place by a device, such that it is translationally static (vertically, horizontally, orthogonally) relative to the chum torpedo disbursement module 200 but may rotate.

The shaft 1115 may, for example, operatively couple one or more annular members 1120. The one or more annular members 1120 may, for example, include one or more apertures 1125. The one or more annular members 1120 may, for example, advantageously enable the scent material to break down. The one or more annular members 1120 may, for example, advantageously enable the internal flow enabler 1105 to rotate.

Although various embodiments have been described with reference to the figures, other embodiments are possible.

In some embodiments, the chum torpedo disbursement module 200 may integrate both mechanical and/or electronic components to optimize functionality. For example, it may include a mechanically operated timer coupled with a basic electronic sensor that detects water pressure to regulate the release of chum at precise depths. This hybrid approach may allow for greater flexibility and accuracy in deployment, catering to various fishing conditions and preferences. The mechanical timer could provide reliability and ease of use, while the electronic sensor enhances precision, potentially increasing the effectiveness of attracting target fish species. Such a combination may ensure that the module remains operational even if one system fails, offering a robust solution for serious anglers. The integration of both systems may significantly enhance the utility and appeal of the chum torpedo disbursement module 200 in diverse fishing environments.

In some embodiments, the chum torpedo disbursement module 200 may feature a manually adjustable fin system to control its navigation through the water. This system may allow users to change the angle of the fins mechanically, thereby adjusting the module's path and stability under various water currents. The adjustability may enable more targeted scent dispersal, optimizing the module's attraction capabilities in different fishing conditions. Such fin customizations may be valuable in areas with complex underwater currents or when targeting specific types of fish that respond to subtle changes in bait presentation. The chum torpedo disbursement module 200 could therefore offer enhanced control over the fishing process, increasing the likelihood of a successful catch. The use of durable, corrosion-resistant materials in the fin system may also ensure long-lasting performance and reliability.

In some embodiments, the chum torpedo disbursement module 200 could be equipped with a dual-release mechanism. This feature may allow the module to carry two types of bait or chum, releasing them sequentially through a simple mechanical lever system. Such versatility may be important for attracting a broader range of fish species or for adapting to different stages of fishing—initial attraction and final strike. This dual-release mechanism may, for example, incorporate very basic electronic controls to fine-tune the timing between releases, enhancing the strategic deployment of scents. The combination of mechanical robustness and electronic precision in this context may provide a significant tactical advantage to anglers. The dual-release system may, therefore, represent a significant innovation, adding considerable value to the chum torpedo disbursement module 200.

In some embodiments, the chum torpedo disbursement module 200 may include a simple agitator inside the chum compartment. This agitator may, for example, ensure that the chum or bait remains loose and capable of easy dispersal through the module's release ports. A crank or spring-loaded mechanism could drive this agitator, possibly supplemented by a minimal electronic timer to activate it periodically. This combination may prevent clumping and ensure a steady, effective scent trail is maintained, crucial for attracting fish over a longer duration or in colder waters where materials might otherwise consolidate. The use of such an agitator may enhance the effectiveness of the chum torpedo disbursement module 200, making it a more attractive option for serious fishing enthusiasts.

In some embodiments, the chum torpedo disbursement module 200 may feature a retractable anchor mechanism. This feature may allow the module to maintain its position in strong currents or to stay within a productive fishing area without drifting. The anchor could be deployed mechanically via a robust, hand-operated winch system, potentially supported by a basic electronic depth finder to gauge the ideal anchoring depth. This functionality may enhance the module's usability in various marine environments, providing stability and increasing the efficacy of the chum dispersal in attracting nearby fish. The ability to anchor the module could prove particularly advantageous during extended fishing sessions or in highly competitive environments where maintaining a strategic position is crucial.

In some embodiments, the chum torpedo disbursement module 200 may be designed to be easily disassembled for maintenance and cleaning. This design may include threaded connections and simple locking mechanisms that can be operated manually, reducing the need for tools. Such a feature may be complemented by minimal electronic diagnostics to alert users when maintenance is due. The ease of maintenance may not only extend the life of the module but also ensure its optimal performance during fishing expeditions. Regular cleaning of the module's internal components, especially the scent dispersal system, may prevent blockages and maintain the effectiveness of scent release, which may be important for successful deep-water fishing.

In some embodiments, the chum torpedo disbursement module 200 may incorporate interchangeable scent cartridges. These cartridges may be mechanically inserted and locked into place, providing an easy way to switch between different types of bait or chum depending on the target species. Minimal electronic tracking could be used to monitor the usage levels of each cartridge, helping anglers keep track of their bait stocks. This feature may streamline the process of preparing for trips and allow for quick adjustments based on real-time observations and fishing conditions. The ability to swap cartridges easily may greatly enhance the flexibility and effectiveness of the chum torpedo disbursement module 200 in diverse fishing scenarios.

In some embodiments, the chum torpedo disbursement module 200 could include a collapsible design for easy storage and transport. This feature may involve mechanical hinges and locking pins that secure the module in both deployed and stored states. An electronic interface could be used to ensure that all components are securely locked before deployment, preventing accidental releases or malfunctions. This collapsibility may be particularly beneficial for anglers who travel frequently and need a compact, reliable tool that can be easily transported between fishing locations. The design may balance mechanical simplicity with minimal electronic enhancements to ensure both portability and reliability, appealing to mobile and versatile fishing enthusiasts.

In some embodiments, the chum torpedo disbursement module 200 might offer an enhanced hydrodynamic shape to minimize drag and improve maneuverability through water. This design could involve mechanically optimized contours and surfaces that reduce resistance and facilitate smoother movement. While primarily mechanical, this feature might be refined with basic computational fluid dynamics software to maximize efficiency before production. The improved hydrodynamics may allow for faster deployment to the desired depth and more effective trailing of the scent cloud, crucial for attracting fast-moving or deep-water fish species. The chum torpedo disbursement module's 200 design efficiency in this regard could provide a significant competitive edge in sports fishing and commercial applications alike.

Although an exemplary system has been described with reference to FIGS. 1-11, other implementations may be deployed in other industrial, scientific, medical, commercial, and/or residential applications.

In industrial applications, the chum torpedo disbursement module 200 may, for example, be adapted to test water currents and dispersion patterns in large-scale operations. In these settings, the device may, for example, be used to monitor environmental impact by releasing non-toxic, traceable compounds at specific depths. In industrial environments, the chum torpedo disbursement module 200 may, for example, be equipped with sensors to gather data on water quality and movement. In such applications, modifications may include the addition of advanced telemetry systems to provide real-time data to operators. In industrial uses, the chum torpedo disbursement module 200 may, for example, help in the deployment of substances that neutralize pollutants. In industrial scenarios, the chum torpedo disbursement module's 200 ability to release contents at a controlled depth may, for example, be crucial for underwater construction and repair tasks.

In scientific research, the chum torpedo disbursement module 200 may, for example, be used to study aquatic life by dispersing biological attractants at predetermined depths. In these applications, the chum torpedo disbursement module 200 may, for example, be crucial for tracking migration patterns of marine species by creating a controlled lure zone. In scientific settings, the chum torpedo disbursement module 200 may, for example, include various modular attachments to facilitate the collection of environmental DNA from attracted species. In scientific explorations, this chum torpedo disbursement module 200 may, for example, also be equipped with cameras and other monitoring equipment to observe behavioral responses. In research applications, the chum torpedo disbursement module 200 may, for example, serve as a tool for ecological studies, helping scientists understand predator-prey interactions. In the field of marine biology, the chum torpedo disbursement module 200 may, for example, be used to conduct controlled experiments on the effects of scent markers on fish behavior.

In medical applications, the chum torpedo disbursement module 200 may, for example, be reconfigured to deploy pharmaceuticals in aquatic farm environments to treat large populations of fish. In these applications, the chum torpedo disbursement module 200 may, for example, ensure precise delivery of treatments to targeted areas, minimizing waste and maximizing effect. In medical contexts, the chum torpedo disbursement module 200 may, for example, also be used in research studies to understand the dispersion of medicinal compounds in fluid environments. In such uses, the chum torpedo disbursement module 200 may, for example, be adapted to release bioactive compounds that could help in the study of waterborne diseases. In medical scenarios, modifications may include the integration of biodegradable capsules that dissolve at controlled rates. In medical applications, the chum torpedo disbursement module 200 may, for example, help in environmental health studies by simulating the spread of potential contaminants.

In commercial applications, the chum torpedo disbursement module 200 may, for example, be utilized by fishing companies to enhance catch rates through strategic scent dispersion. In these scenarios, the chum torpedo disbursement module 200 may, for example, allow for more efficient fishing operations by reducing the time spent searching for fish schools. In commercial settings, the chum torpedo disbursement module 200 may, for example, be adapted to operate at varying depths suitable for different fish species. In commercial operations, the ability to disperse chum or bait uniformly may, for example, lead to more sustainable fishing practices by targeting specific species and reducing bycatch. In such applications, the chum torpedo disbursement module 200 may, for example, also incorporate GPS tracking to record successful fishing locations. In commercial fisheries, the chum torpedo disbursement module 200 may, for example, be linked to automated systems for synchronized deployment across multiple vessels.

In residential applications, the chum torpedo disbursement module 200 may, for example, be used by hobbyist anglers to enhance their fishing experience. In these cases, the chum torpedo disbursement module 200 may, for example, be simplified for easy use and maintenance by individuals. In residential use, the chum torpedo disbursement module 200 may, for example, include customizable settings to control the depth and duration of scent release according to personal preferences. In such applications, the chum torpedo disbursement module 200 may, for example, also be marketed with various scent options tailored for different types of fish, enhancing its appeal. In residential settings, the chum torpedo disbursement module 200 may, for example, include safety features to ensure it is user-friendly and secure for all ages. In home use, the chum torpedo disbursement module 200 may, for example, be compact and portable, making it easy to store and transport for occasional outings.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A submersible scent material dispersal device comprising:
a body configured to house scent material and extending along a longitudinal axis comprising:
one or more directional members along an outer surface of the body configured to influence movement of the body through a fluid environment;
a propulsion device comprising:
a forward propeller at a proximal end of the body;
an internal flow enabler housed within the body and operatively coupled to the forward propeller; and
a rear propeller at a distal end of the body and operatively coupled to the internal flow enabler;
one or more inlets at the proximal end of the body positioned around the longitudinal axis of the body; and,
one or more outlets at the distal end of the body;
wherein, the body is configured to tether to a depth control apparatus such that when the body is pulled through water, a proximal end of the body defining a front portion of the body that leads in a direction of travel, such that pulling the body in the direction of travel causes dispersal of the scent material from the body through the one or more outlets of the body at a desired predetermined depth level as the body moves at a predetermined velocity, and,
one or more cartridges configured to house scent material and configured to operatively couple the body along the outer surface of the body,
wherein when the one or more cartridges is pulled through water, a proximal end of the one or more cartridges defining a front portion of the one or more cartridges that leads in the direction of travel, such that pulling the one or more cartridges in the direction of travel causes dispersal of the scent material from the one or more cartridges at a desired predetermined depth level as the one or more cartridges moves at a predetermined velocity.

2. The submersible scent material dispersal device of claim 1, wherein the one or more directional members further comprise one or more guiding fins.

3. The submersible scent material dispersal device of claim 1, wherein the one or more directional members further comprise one or more manually adjustable fins configured to change an angle of the one or more fins mechanically.

4. The submersible scent material dispersal device of claim 1, wherein the body further comprises a scent material inlet configured to receive scent material.

5. The submersible scent material dispersal device of claim 1, wherein the scent material further comprises chum.

6. The submersible scent material dispersal device of claim 1, wherein the depth control apparatus comprises a downrigger cable and a downrigger ball.

7. The submersible scent material dispersal device of claim 1, wherein the one or more cartridges further comprise one or more apertures configured to release scent if an internal cavity within the one or more cartridges is filled with scent materials and as the one or more cartridges move through water.

8. The submersible scent material dispersal device of claim 1, wherein the internal flow enabler further comprises:
a shaft; and,
one or more blades operatively coupled to the shaft, wherein the shaft is affixed in place within the body, such that the shaft is translationally static relative to the body and configured to rotate within the body.

9. The submersible scent material dispersal device of claim 1, wherein the internal flow enabler further comprises an auger.

10. The submersible scent material dispersal device of claim 1, wherein the depth control apparatus further comprises a retractable anchor operatively coupled to the body.

11. A submersible scent material dispersal device comprising:
a body configured to house scent material and extending along a longitudinal axis comprising:
one or more directional members along an outer surface of the body configured to influence movement of the body through a fluid environment;
a propulsion device comprising:
a forward propeller at a proximal end of the body;
an internal flow enabler housed within the body and operatively coupled to the forward propeller; and
a rear propeller at a distal end of the body and operatively coupled to the internal flow enabler;
one or more inlets at the proximal end of the body positioned around the longitudinal axis of the body; and
one or more outlets at the distal end of the body,
wherein, the body is configured to tether to a depth control apparatus such that when the body is pulled through water, the proximal end of the body defining a front portion of the body that leads in a direction of travel, such that pulling the body in the direction of travel causes dispersal of the scent material from the body through the one or more outlets of the body at a desired predetermined depth level as the body moves at a predetermined velocity.

12. The submersible scent material dispersal device of claim 11, wherein the one or more directional members further comprise one or more guiding fins.

13. The submersible scent material dispersal device of claim 11, wherein the one or more directional members further comprise one or more manually adjustable fins configured to change an angle of the one or more fins mechanically.

14. The submersible scent material dispersal device of claim 11, wherein the body further comprises a scent material inlet configured to receive scent material.

15. The submersible scent material dispersal device of claim 11, wherein the scent material further comprises chum.

16. The submersible scent material dispersal device of claim 11, wherein the depth control apparatus comprises a downrigger cable and a downrigger ball.

17. The submersible scent material dispersal device of claim 11, wherein the internal flow enabler further comprises:
a shaft; and,
one or more blades operatively coupled to the shaft, wherein the shaft is affixed in place within the body, such that the shaft is translationally static relative to the body and configured to rotate within the body.

18. The submersible scent material dispersal device of claim 11, wherein the internal flow enabler further comprises an auger.

19. The submersible scent material dispersal device of claim 11, wherein the depth control apparatus further comprises a retractable anchor operatively coupled to the body.

20. A submersible scent material dispersal device comprising:
one or more cartridges configured to house scent material and configured to operatively couple a body along an outer surface of the body, the body comprising:
one or more directional members along an outer surface of the body configured to influence movement of the body through a fluid environment;
a propulsion device comprising:
a forward propeller at a proximal end of the body;
an internal flow enabler housed within the body and operatively coupled to the forward propeller; and
a rear propeller at a distal end of the body and operatively coupled to the internal flow enabler;
one or more inlets at the proximal end of the body positioned around a longitudinal axis of the body; and
one or more outlets at the distal end of the body,
wherein, the body is configured to tether to a depth control apparatus such that when the body is pulled through water, the proximal end of the body defining a front portion of the body that leads in a direction of travel, such that pulling the body in the direction of travel causes dispersal of the scent material from the body through the one or more outlets of the body at a desired predetermined depth level as the body moves at a predetermined velocity; and,
wherein when the one or more cartridges is pulled through water, a proximal end of the one or more cartridges defining a front portion of the one or more cartridges that leads in the direction of travel, such that pulling the one or more cartridges in the direction of travel causes dispersal of the scent material from the one or more cartridges at a desired predetermined depth level as the one or more cartridges moves at a predetermined velocity.
